(19) United States
(12) Patent Application Publication
(10) Pub. No.: US 2014/0144471 A1
(43) Pub. Date: May 29, 2014

(54) Contamination Control, Rinsing, and Purging Methods to Extend the Life of Components within Combinatorial Processing Systems

(71) Applicant: INTERMOLLECULAR, INC., San Jose, CA (US)

(72) Inventors: Satbir Kahlon, Livermore, CA (US); Aaron T. Francis, San Jose, CA (US); Chi-I Lang, Cupertino, CA (US); Gregory P. Lim, Fremont, CA (US); Jeffrey Chih-Hou Lowe, Cupertino, CA (US); Robert Anthony Sculac, Lake Oswego, OR (US)

(73) Assignee: INTERMOLECULAR, INC., San Jose, CA (US)

(21) Appl. No.: 13/688,045

(22) Filed: Nov. 28, 2012

(51) Int. Cl. B08B 9/032

(52) U.S. Cl. CPC B08B 9/0321
USPC 134/22.12

(57) ABSTRACT

Methods and apparatuses for controlling contamination within processing modules and extending the life of system components within processing modules of combinatorial processing systems are disclosed. Methods include injecting a purging fluid into distribution lines within a processing module after one step of a process recipe. Further, injecting a flushing fluid into the distribution lines after the purging fluid is introduced therein. Furthermore, injecting the purging fluid and the flushing fluid into the fluid distribution line multiple times before initiating a next step of the process recipe. Finally, injecting a purging fluid into the distribution lines before initiating a next process step.

### FIELD

The present disclosure relates to methods and apparatuses for increasing the operational robustness and safety of combinatorial processing systems.

### BACKGROUND

A F30 tool is a combinatorial research and development system capable of accommodating and dispensing various fluids. Fluids within the F30 tool are partitioned into two sides wherein each side has one dispense manifold to deliver fluids to a reactor unit. The dispense manifolds can deliver fluids to various mixing vessels through any number of fluid distribution lines.

Dispense manifolds typically function to dispense various process fluids in sequence which causes cross-contamination. Cross-contamination can lead to unstable etch rates and defects in the processed substrates. There are three major sources of contamination:

Source-01: Process fluids are introduced into one end of each fluid distribution channel and are dispensed to open fluid distribution lines coupled thereto. Oftentimes, the process fluids linger at the opposite end near the syringe, pressure relief valve, and the fluid distribution line coupled to the first mixing vessel (MV-01). As such, lingering process fluids in this area ultimately becomes a source of uncontrolled contamination. Source-02: Generally, each fluid distribution line within the dispense manifolds are coupled to fluid distribution channels via two-way valves which have an inlet port and an outlet port. Remnants of dispensed process fluids remain in the output ports become an uncontrolled source of contamination. Source-03: Another source of contamination is caused by the dispensing order of process fluids within the dispense manifolds.

Accordingly, what is needed is an effective method to control contamination and extend the life of components within combinatorial processing systems. The present disclosure addresses such a need.

### SUMMARY OF THE DISCLOSURE

The following summary is included in order to provide a basic understanding of some aspects and features of the present disclosure. This summary is not an extensive overview of the disclosure and as such it is not intended to particularly identify key or critical elements of the disclosure or to delineate the scope of the disclosure. Its sole purpose is to present some concepts of the disclosure in a simplified form as a prelude to the more detailed description that is presented below.

Methods and apparatuses for controlling contamination within processing modules and extending the life of system components within processing modules of combinatorial processing systems are disclosed. Methods include injecting a purging fluid into distribution lines within a processing module after one step of a process recipe. Further, injecting a flushing fluid into the distribution lines after the purging fluid is introduced therein. Furthermore, injecting the purging fluid and the flushing fluid into the fluid distribution line multiple times before initiating a next step of the process recipe. Finally, injecting a purging fluid into the distribution lines before initiating a next process step.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale. The techniques of the present disclosure may readily be understood by considering the following detailed description in conjunction with the accompanying drawings, in which:

FIG. 1 is a schematic diagram for implementing combinatorial processing and evaluation.

FIG. 2 is a schematic diagram for illustrating various process sequences using combinatorial processing and evaluation.

FIG. 3 is a simplified schematic diagram illustrating a processing module of a combinatorial processing system which may incorporate processing experiments or semiconductor manufacturing process sequences and unit operations in order to combinatorially evaluate various semiconductor manufacturing processes.

FIG. 4 is a simplified schematic diagram illustrating a dispense manifold operable within a processing module of a combinatorial processing system.

FIG. 5 is a simplified schematic diagram illustrating a mixing vessel unit, having a plurality of mixing vessels, and operable within a processing module of a combinatorial processing system.

FIG. 6 is a perspective view of a reactor unit within the processing module of a combinatorial processing system.

FIG. 7 illustrates one example of a substrate having a pattern of site-isolated regions.

FIG. 8 is a simplified schematic diagram of a chart listing the pH of a control solution and sample solutions after the sample solutions are injected into the system before a decontamination method is applied thereto.

FIG. 9 is a simplified schematic flow diagram of a method to decontaminate a processing module of a combinatorial processing system.

FIG. 10 is a simplified schematic diagram of a table listing the pH of sample substances after process fluids are injected into the system and after a decontamination method is applied thereto.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Methods and apparatuses for controlling contamination within processing modules and extending the life of system components within processing modules of combinatorial processing systems are disclosed. Methods include injecting a purging fluid into distribution lines within a processing module after one step of a process recipe. Further, injecting a flushing fluid into the distribution lines after the purging fluid is introduced therein. Furthermore, injecting the purging fluid and the flushing fluid into the fluid distribution line multiple times before initiating a next step of the process recipe. Finally, injecting a purging fluid into the distribution lines before initiating a next process step.

It is to be understood that unless otherwise indicated this disclosure is not limited to specific layer compositions or surface treatments. It is also to be understood that the terminology used herein is for the purpose of describing particular embodiments only and is not intended to limit the scope of the present disclosure.

It must be noted that as used herein and in the claims, the singular forms “a,” and “the” include plural referents unless the context clearly dictates otherwise. Thus, for example, reference to “a layer” also includes two or more layers, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” generally refers to ±10% of a stated value.

The term “site-isolated” as used herein refers to providing distinct processing conditions, such as controlled temperature, flow rates, chamber pressure, processing time, plasma composition, and plasma energies. Site isolation may provide complete isolation between regions or relative isolation between regions. Preferably, the relative isolation is sufficient to provide a control over processing conditions within ±10%, within ±5%, within ±2%, within ±1%, or within ±0.1% of the target conditions. Where one region is processed at a time, adjacent regions are generally protected from any exposure that would alter the substrate surface in a measurable way.

The term “site-isolated region” is used herein to refer to a localized area on a substrate which is, was, or is intended to be used for processing or formation of a selected material. The region may include one region and/or a series of regular or periodic regions predefined on the substrate. The region may have any convenient shape, e.g., circular, rectangular, elliptical, wedge-shaped, etc. In the semiconductor field, a region may be, for example, a test structure, single die, multiple dies, portion of a die, other defined portion of substrate, or an undefined area on a substrate, e.g., blanket substrate which is defined through the processing.

The term “substrate” as used herein may refer to any workpiece on which formation or treatment of material layers is desired. Substrates may include, without limitation, silicon, coated silicon, other semiconductor materials, glass, polymers, metal foils, etc. The term “substrate” or “wafer” may be used interchangeably herein. Semiconductor wafer shapes and sizes may vary and include commonly used round wafers of 2″, 4″, 200 mm, or 300 mm in diameter.

It is desirable to be able to i) test different materials, ii) test different processing conditions within each unit process module, iii) test different sequencing and integration of processing modules within an integrated processing tool, iv) test different sequencing of processing tools in executing different process sequence integration flows, and combinations thereof in the manufacture of devices. In particular, there is a need to be able to test i) more than one material, ii) more than one processing condition, iii) more than one sequence of processing conditions, iv) more than one process sequence integration flow, and combinations thereof, collectively known as “combinatorial process sequence integration”, on a single substrate without the need of consuming the equivalent number of monolithic substrates per material(s), processing condition(s), sequence(s) of processing conditions, sequence(s) of processes, and combinations thereof. This may greatly improve both the speed and reduce the costs associated with the discovery, implementation, optimization, and qualification of material(s), process(es), and process integration sequence(s) required for manufacturing.

Systems and methods for HPC™ processing are described in U.S. Pat. No. 7,544,574 filed on Feb. 10, 2006; U.S. Pat. No. 7,824,935 filed on Jul. 2, 2008; U.S. Pat. No. 7,871,928 filed on May 4, 2009; U.S. Pat. No. 7,902,063 filed on Feb. 10, 2006; and U.S. Pat. No. 7,947,531 filed on Aug. 28, 2009 which are all herein incorporated by reference for all purposes. Systems and methods for HPC™ processing are further described in U.S. patent application Ser. No. 11/352,077 filed on Feb. 10, 2006, claiming priority from Oct. 15, 2005; U.S. patent application Ser. No. 11/419,174 filed on May 18, 2006, claiming priority from Oct. 15, 2005; U.S. patent application Ser. No. 11/674,132 filed on Feb. 12, 2007, claiming priority from Oct. 15, 2005; and U.S. patent application Ser. No. 11/674,137 filed on Feb. 12, 2007, claiming priority from Oct. 15, 2005 which are all herein incorporated by reference for all purposes.

HPC™ processing techniques have been successfully adapted to wet chemical processing such as etching, texturing, polishing, cleaning, etc. HPC™ processing techniques have also been successfully adapted to deposition processes such as physical vapor deposition (PVD) (i.e. sputtering), atomic layer deposition (ALD), and chemical vapor deposition (CVD).

In addition, systems and methods for combinatorial processing and further described in U.S. patent application Ser. No. 13/341,993 filed on Dec. 31, 2011 and U.S. patent application Ser. No. 13/302,730 filed on Nov. 22, 2011 which are all herein incorporated by reference for all purposes.

HPC™ processing techniques have been adapted to the development and investigation of absorber layers and buffer layers for TFPV solar cells as described in U.S. patent application Ser. No. 13/236,430 filed on Sep. 19, 2011, entitled “COMBINATORIAL METHODS FOR DEVELOPING SUPERSTRATE THIN FILM SOLAR CELLS” and is incorporated herein by reference for all purposes.

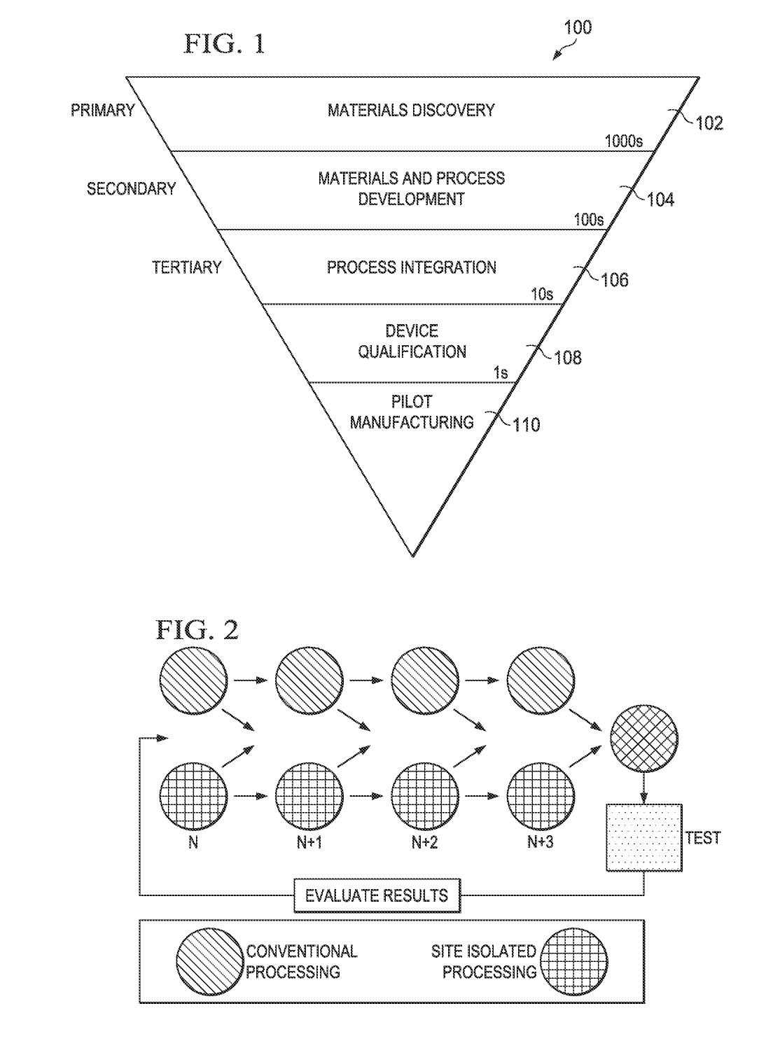

FIG. 1 illustrates a schematic diagram 100 for implementing combinatorial processing and evaluation using primary, secondary, and tertiary screening. The schematic diagram 100 illustrates that the relative number of combinatorial processes run with a group of substrates decreases as certain materials and/or processes are selected. Generally, combinatorial processing includes performing a large number of processes during a primary screen, selecting promising candidates from those processes, performing the selected processing during a secondary screen, selecting promising candidates from the secondary screen for a tertiary screen, and so on. In addition, feedback from later stages to earlier stages may be used to refine the success criteria and provide better screening results.

For example, thousands of materials are evaluated during a materials discovery stage 102. Materials discovery stage 102 is also known as a primary screening stage performed using primary screening techniques. Primary screening techniques may include dividing substrates into coupons and depositing materials using varied processes. The materials are then evaluated, and promising candidates are advanced to the secondary screen, or materials and process development stage 104. Evaluation of the materials is performed using metrology tools such as electronic testers and imaging tools (i.e. microscopes).

The materials and process development stage, 104, may evaluate hundreds of materials (i.e., a magnitude smaller than the primary stage) and may focus on the processes used to deposit or develop those materials. Promising materials and processes are again selected, and advanced to the tertiary screen or process integration stage 106 where tens of materials and/or processes and combinations are evaluated. The tertiary screen or process integration stage 106 may focus on integrating the selected processes and materials with other processes and materials.

The most promising materials and processes from the tertiary screen are advanced to device qualification 108. In device qualification, the materials and processes selected are evaluated for high volume manufacturing, which normally is conducted on full substrates within production tools, but need not be conducted in such a manner. The results are evaluated to determine the efficacy of the selected materials and processes. If successful, the use of the screened materials and processes may proceed to pilot manufacturing 110.

The schematic diagram 100 is an example of various techniques that may be used to evaluate and select materials and processes for the development of new materials and processes. The descriptions of primary, secondary, etc. screening and the various stages 102-110 are arbitrary and the stages may overlap, occur out of sequence, be described and be performed in many other ways.

This application benefits from HPC™ techniques described in U.S. patent application Ser. No. 11/674,137 filed on Feb. 12, 2007 which is hereby incorporated for reference for all purposes. Portions of the '137 application have been reproduced below to enhance the understanding of the present disclosure.

While the combinatorial processing varies certain materials, unit processes, hardware details, or process sequences, the composition or thickness of the layers or structures or the action of the unit process, such as cleaning, surface preparation, deposition, surface treatment, etc. is substantially uniform through each discrete site-isolated region. Furthermore, while different materials or unit processes may be used for corresponding layers or steps in the formation of a structure in different site-isolated regions of the substrate during the combinatorial processing, the application of each layer or use of a given unit process is substantially consistent or uniform throughout the different site-isolated regions in which it is intentionally applied.

Thus, the processing is uniform within a site-isolated region (inter-region uniformity) and between site-isolated regions (intra-region uniformity), as desired. It should be noted that the process may be varied between site-isolated regions, for example, where a thickness of a layer is varied or a material may be varied between the site-isolated regions, etc., as desired by the design of the experiment.

The result is a series of site-isolated regions on the substrate that contain structures or unit process sequences that have been uniformly applied within that site-isolated region and, as applicable, across different site-isolated regions. This process uniformity allows comparison of the properties within and across the different site-isolated regions such that the variations in test results are due to the varied parameter (e.g., materials, unit processes, unit process parameters, hardware details, or process sequences) and not the lack of process uniformity. In the embodiments described herein, the positions of the discrete site-isolated regions on the substrate may be defined as needed, but are preferably systematized for ease of tooling and design of experimentation. In addition, the number, variants and location of structures within each site-isolated region are designed to enable valid statistical analysis of the test results within each site-isolated region and across site-isolated regions to be performed.

FIG. 2 is a simplified schematic diagram illustrating a general methodology for combinatorial process sequence integration that includes site-isolated processing and/or conventional processing. In some embodiments, the substrate is initially processed using conventional process N. In some exemplary embodiments, the substrate is then processed using site-isolated process N+1. During site-isolated processing, an HPC™ module may be used, such as the HPC module described in U.S. patent application Ser. No. 11/352,077 filed on Feb. 10, 2006, which is incorporated herein by reference for all purposes. The substrate may then be processed using site-isolated process N+2, and thereafter processed using conventional process N+3. Testing is performed and the results are evaluated. The testing may include physical, chemical, acoustic, magnetic, electrical, optical, etc. tests. From this evaluation, a particular process from the various site isolated processes (e.g. from steps N+1 and N+2) may be selected and fixed so that additional combinatorial process sequence integration may be performed using site isolated processing for either process N or N+3. For example, a next process sequence may include processing the substrate using site isolated process N, conventional processing for processes N+1, N+2, and N+3, with testing performed thereafter.

It should be appreciated that various other combinations of conventional and combinatorial processes may be included in the processing sequence with regard to FIG. 2. That is, the combinatorial process sequence integration may be applied to any desired segments and/or portions of an overall process flow. Characterization, including physical, chemical, acoustic, magnetic, electrical, optical, etc. testing, may be performed after each process operation, and/or series of process operations within the process flow as desired. The feedback provided by the testing is used to select certain materials, processes, process conditions, and process sequences and eliminate others. Furthermore, the above flows may be applied to entire monolithic substrates, or portions of monolithic substrates such as coupons.

Under combinatorial processing operations the processing conditions at different site-isolated regions may be controlled independently. Consequently, process material amounts, reactant species, processing temperatures, processing times, processing pressures, processing flow rates, processing powers, processing reactant compositions, the rates at which the reactions are quenched, deposition order of process materials, process sequence steps, hardware details, etc., may be varied from site-isolated region to site-isolated region on the substrate. Thus, for example, when exploring materials, a processing material delivered to a first and second site-isolated regions may be the same or different. If the processing material delivered to the first site-isolated region is the same as the processing material delivered to the second isolated-region, this processing material may be offered to the first and second site-isolated regions on the substrate at different concentrations. In addition, the material may be deposited under different processing parameters. Parameters which may be varied include, but are not limited to, process material amounts, reactant species, processing temperatures, processing times, processing pressures, processing flow rates, processing powers, processing reactant compositions, the rates at which the reactions are quenched, atmospheres in which the processes are conducted, an order in which materials are deposited, hardware details of the gas distribution assembly, etc. It should be appreciated that these process parameters are exemplary and not meant to be an exhaustive list as other process parameters commonly used may be varied.

As mentioned above, within a site-isolated region, the process conditions are substantially uniform. That is, the embodiments, described herein locally perform the processing in a conventional manner, e.g., substantially consistent and substantially uniform, while globally over the substrate, the materials, processes, and process sequences may vary. Thus, the testing will find optimums without interference from process variation differences between processes that are meant to be the same. However, in some embodiments, the processing may result in a gradient within the site-isolated regions. It should be appreciated that a site-isolated region may be adjacent to another site-isolated region in some embodiments or the site-isolated regions may be isolated and, therefore, non-overlapping. When the site-isolated regions are adjacent, there may be a slight overlap wherein the materials or precise process interactions are not known, however, a portion of the site-isolated regions, normally at least 50% or more of the area, is uniform and all testing occurs within that site-isolated region. Further, the potential overlap is only allowed with material of processes that will not adversely affect the result of the tests. Both types of site-isolated regions are referred to herein as site-isolated regions or discrete site-isolated regions.

Substrates may be a conventional round 200 mm, 300 mm, or any other larger or smaller substrate/wafer size. In some embodiments, substrates may be square, rectangular, or any other shape. One skilled in the art will appreciate that substrate may be a blanket substrate, a coupon (e.g. partial wafer), or even a patterned substrate having predefined site-isolated regions. In some other embodiments, a substrate may have site-isolated regions defined through the processing described herein.

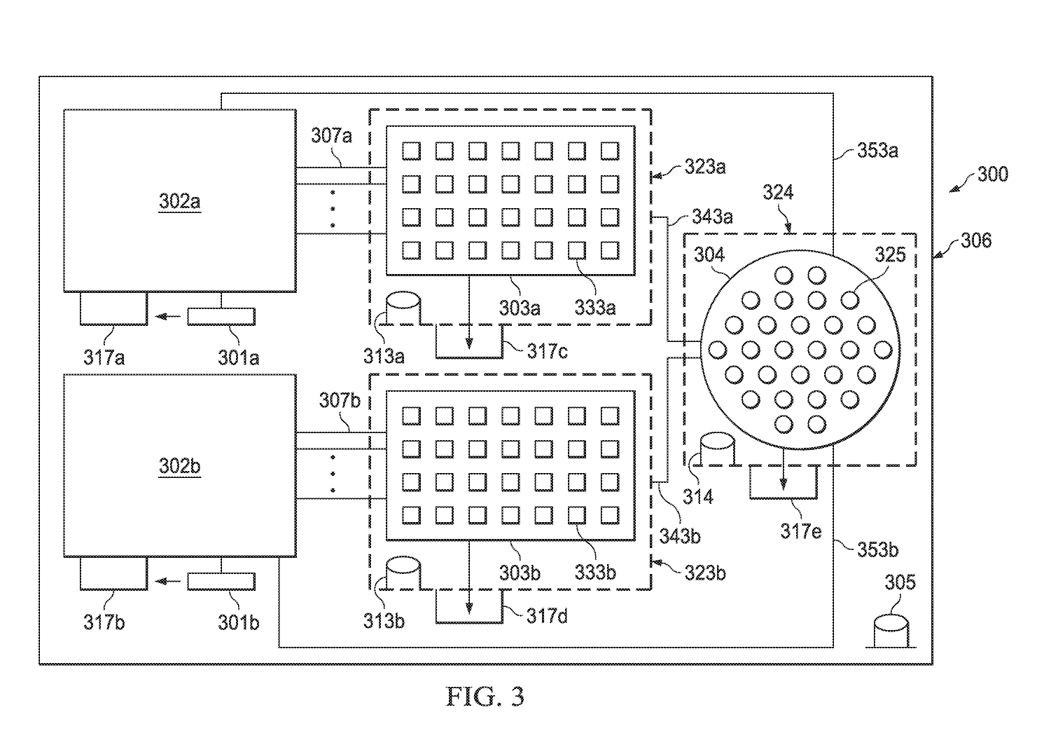

FIG. 3 is a simplified schematic diagram illustrating a processing module 300 of a combinatorial processing system which may incorporate processing experiments or semiconductor manufacturing process sequences and unit operations in order to combinatorially evaluate various semiconductor manufacturing processes. In some embodiments, processing module 300 may perform wet etch processing, texturizing, polishing, and cleaning.

As shown, processing module 300 includes a plurality of sub-components and connections. Exemplary sub-components include dispense manifolds 302a, 302b which dispense process fluids throughout the processing module 300; mixing vessel units 303a, 303b which optionally mixes fluids (e.g. chemicals); reactor unit 304 which processes site-isolated regions on a substrate; and any required power and gas inputs (not shown) to operate the system. In some embodiments, mixing vessel units 303a, 303b and reactor unit 304 have leak trays 317 to capture fluid leaks at each respective area of the processing module 300.

In some embodiments, the leak trays (317c, 317d, 317e, respectively) coupled to the mixing vessel unit 303 and reactor cell 304 each have leak sensors (313a, 313b, 314, respectively) coupled thereto to signal system software about the presence of a fluid leak. As such, in the event a fluid leak is captured in any of the leak trays, the leak sensor coupled thereto sends a signal to system software to subsequently shut down the processing module 300 regardless of whether a substrate within the tool has completed processing.

In some embodiments, dispense manifolds 302a, 302b, mixing vessel units 303a, 303b, and reactor unit 304 are coupled to each other by fluid distribution lines. Each fluid distribution line delivers process fluids to a specific sub-component according to a process recipe. For example, a process recipe may specify that a certain amount of fluids A and B should be mixed together within a mixing vessel and thereafter delivered to a reactor cell to process a specific site-isolated region on a substrate.

Further, beneath the processing module 300 lies a main tray 306 operable to collect fluid leaks. In some embodiments, main tray 306 includes a leak sensor 305 therein. Once a fluid leak is detected, the leak sensor 305 sends a message to system software to shut down all sub-systems within the combinatorial processing tool. Accordingly, when the system shuts down the sub-systems, all processing ceases, the doors to the combinatorial processing system close, and the vacuum system(s) deactivate. Afterwards, a technician or system operator can clean the fluid leak(s) and remove any substrate(s) located in the combinatorial processing system.

In some embodiments, processing module 300 further includes a reactor unit 304 having a plurality of reactor cells 325 to process various site-isolated regions on a substrate. In some embodiments, reactor unit 304 has twenty-eight reactor cells 304 which can process twenty-eight site-isolated regions on a 300 mm diameter wafer.

It should be appreciated that any number of reactor cells 325 may be accommodated within the reactor unit 304 so long as reactor unit 304 can effectively combinatorially process a substrate. In some embodiments, the number of reactor cells 325 depends upon various factors such as the shape and size of the substrate and the shape and size of the site-isolated regions. It should be further appreciated that a monolithic block design or a modular design for the reactor unit 304 may be integrated with some embodiments of the present disclosure.

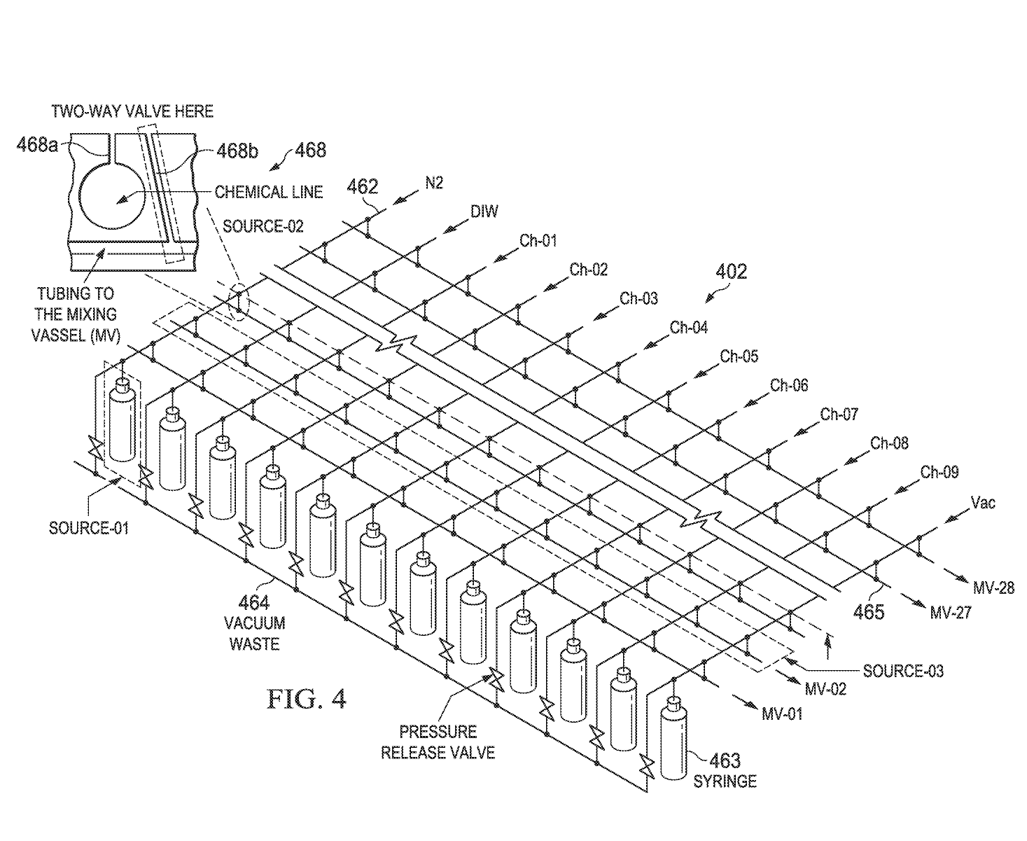

FIG. 4 is a simplified schematic diagram illustrating dispense manifolds 402 operable within a processing module of a combinatorial processing system. Dispense manifolds 402 include a plurality of fluid distribution channels 462. Fluid distribution channels 462 may dispense any of a host of process fluids such as, but not limited to, inert gases, deionized water, and chemicals into the fluid distribution lines 465. In some embodiments, fluid distribution channels 462 may also include vacuum lines as shown in the figure.

Further, in some embodiments, each fluid distribution channel 462 is coupled to fluid sources (not shown) which may provide the source of process fluids to the fluid distribution channels 462. In some embodiments, the fluid sources extend from outside of the combinatorial processing system. Each fluid distribution channel 462 may be coupled to a plurality of fluid distribution lines 465 to deliver fluids to one mixing vessel unit or directly to a reactor unit.

Furthermore, dispense manifold 402 may be coupled to vacuum waste line 464 such that excess fluid in the fluid distribution channels 462 may be disposed from the system. For example, in the event pressure within any of fluid distribution channels 462 exceed a predetermined threshold, a pressure relief valve 467 coupled thereto releases fluid from the fluid distribution channels 462 into vacuum waste line 464 to be disposed. In some embodiments, pressure relief valve 467 releases only enough fluid from the fluid distribution channels 462 to reduce the pressure within the fluid distribution channels 462 to a predefined target pressure.

FIG. 4 further helps illustrate the causes of contamination sources within the combinatorial processing system. A few of the major causes of contamination sources are explained in some detail below:

Source-01: Process fluids are typically introduced into one end of each fluid distribution channel 462. As shown, the other end of each fluid distribution channel 462 is connected to a syringe 466 and a pressure relief valve 467 coupled to waste. Oftentimes, process fluids linger in the area near the syringe 466, pressure relief valve 467, and the fluid distribution line 465 coupled to the first mixing vessel (MV-01) becoming a source of uncontrolled contamination. Unfortunately, this area is hard to decontaminate during a system's normal operation.

Source-02: Generally, each fluid distribution line 465 within dispense manifold 402 is crossed-drilled with twelve bores as entry for process fluids dispensed by the fluid distribution channels 462 via two-way valves 468. The two-way valves 468 have an inlet port 468a and an outlet port 468b through which process fluids are delivered to the fluid distribution lines 465 from the fluid distribution channels 462. Oftentimes, remnants of dispensed process fluids remain in the output ports 468b becoming an uncontrolled source of contamination.

Source-03: Finally, the dispensing order of process fluids within dispense manifold 402 may be another source of contamination. Because the fluid distribution channels 462 are connected in series, if any of the upstream fluid distribution channels 462 dispense fluids to the fluid distribution lines 465 first, then remnants of the process fluid(s) may linger in the fluid distribution line and may become a source of contamination for process fluids later dispended from fluid distribution channels 462 downstream.

For example, if a process recipe calls for a process fluid from ch-09 to be dispensed into a certain fluid distribution line 465, unwanted residual process fluids lingering in the fluid distribution lines 465 dispensed previously from ch-01 to ch-08, can consequently mix with the process fluid(s) presently dispensing from ch-09.

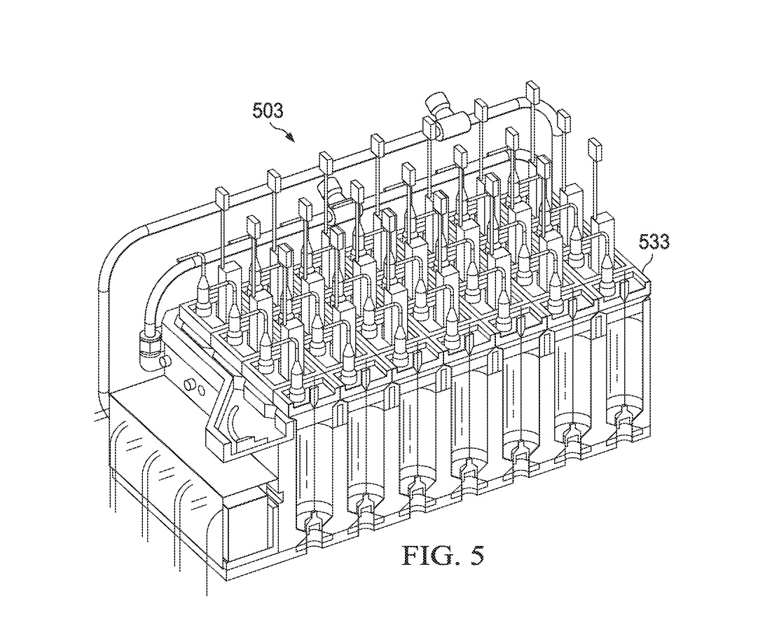

FIG. 5 is a simplified schematic diagram illustrating a mixing vessel unit 503 having a plurality of mixing vessels 533 and operable within a processing module of a combinatorial processing system. In some embodiments, mixing vessel unit 503 includes twenty-eight mixing vessels 533 which mix two or more fluids (e.g. chemicals) therein. For example, two or more fluids may be mixed within a mixing vessel 533 to produce a desired solution which may be delivered to a reactor cell of a reactor unit to combinatorially process various site-isolated regions on a substrate.

Over time, process fluids may erode components of the mixing vessels 533 and the mixing vessel unit 503. Further, residual process fluids from previous process steps may remain in the mixing vessels 533 affecting the chemical or material properties of later dispensed process fluids mixed within the vessels 533.

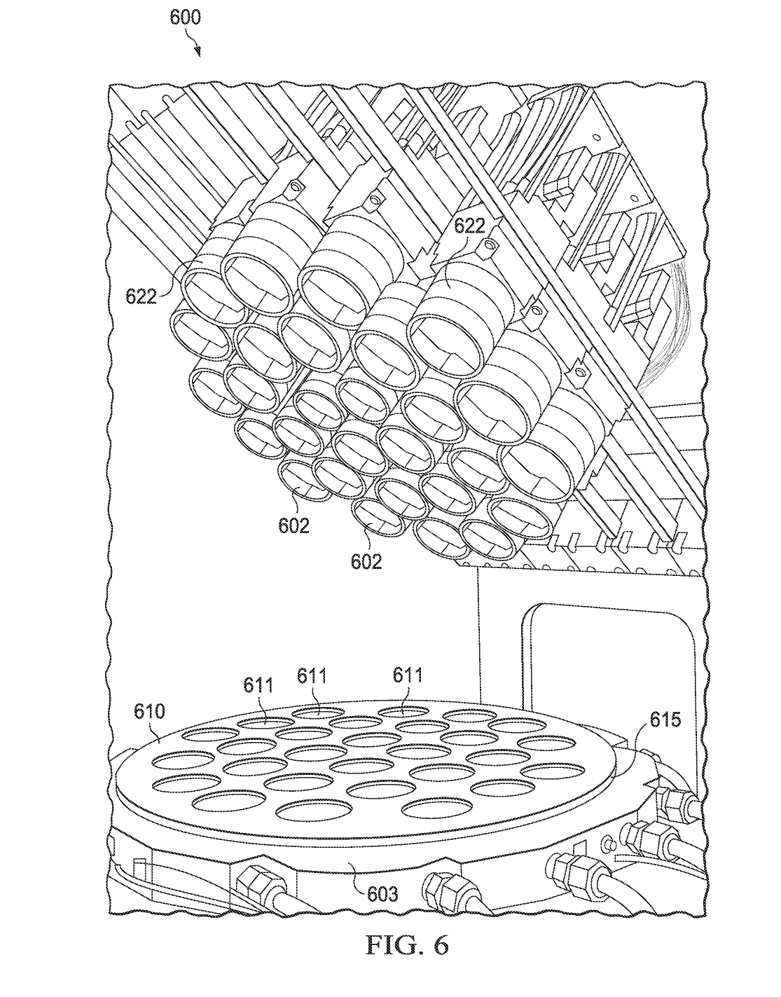

FIG. 6 is a perspective view of a reactor unit 600 having a plurality of reactor cells 602 within a processing module of a combinatorial processing system. As shown, a substrate 610 having a plurality of site-isolated regions on an upper surface limited by an outer edge 615 is loaded within the reactor unit 600. As is evident in the figure, the site-isolated regions 611 have widths (or diameters) that are considerably smaller than a width (or diameter) of the substrate 610. Notably, each site-isolated region 611 may be processed by a corresponding reactor cell 602 of the reactor unit 600. Further, the portion(s) of the substrate 610 located outside the site-isolated regions 611 may be referred to as interstitial regions.

The reactor cells 602 shown in FIG. 6 may be arranged in rows or columns, with each reactor cell 602 corresponding to a site-isolated region 611 on the substrate 610. However, it should be understood that the number and arrangement of the reactor cells 602 may differ, as is appropriate given the size and shape of the substrate 610 and the arrangement of the site-isolated regions 611. In some embodiments, each reactor cell 602 includes a body 622, such as a container or reactor.

A substrate support 603 can be positioned such that the bodies 622 of the reactor cells 602 are disposed above the substrate 610. More specifically, the substrate support 603 can be positioned such that each reactor cell 602 is disposed at a certain predefined gap height over a single site-isolated region 611 on the substrate 610.

Further details about the reactor unit 600 configuration may be found in U.S. patent application Ser. No. 11/352,077 entitled “Methods for Discretized Processing and Process Sequence Integration of Regions of Substrate” filed on Feb. 10, 2006 and claiming priority to U.S. Provisional Application No. 60/725,186 filed on Oct. 11, 2005, and U.S. patent application Ser. No. 11/966,809 entitled “Vented Combinatorial Processing Cell” filed on Dec. 28, 2007, and claiming priority to U.S. Provisional Application No. 61/014,672 filed on Dec. 18, 2007, the entireties of which are hereby incorporated by reference for all purposes.

Moving forward, some parts and components within the processing module may be made of corrosive resistant materials such as PFA, PTFE, etc. However, many parts and components are made from plastic or less corrosive-resistant materials. For example, most valves, electronic components, and fasteners consist of metal which is particularly prone to corrosion.

In addition, many process fluids are pressurized causing the potential for process fluids to leak out from loose fittings or weak seams (e.g. joints) present in the parts and components within the processing module. For example, it is well known that some chemicals such as NH₄OH or HCl can easily diffuse through PFA or PTFE tubing and remain within processing systems.

In the event process fluids leak or diffuse out of their containment and subsequently come in contact with system components, the process fluids can react with these components resulting in detrimental effects to the tool. For example, powder may form on components affecting the mechanical integrity of the components and parts of other components could dissolve or corrode. Accordingly, an effective method to control contamination and extend the life of components within the combinatorial processing system is needed.

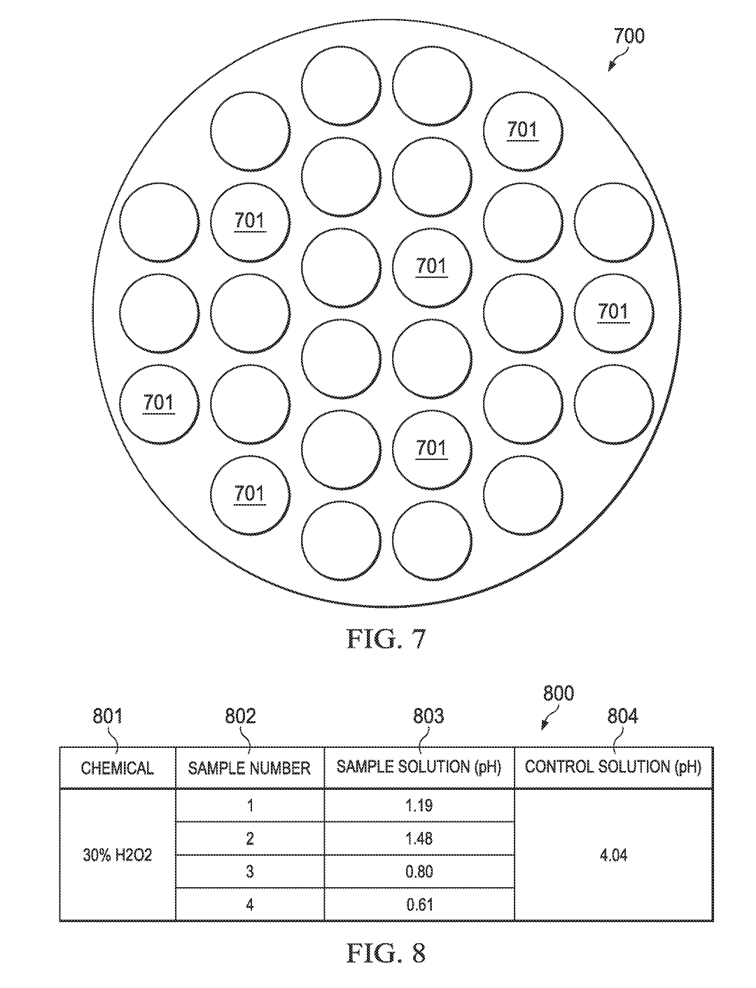

FIG. 7 illustrates one example of a substrate 700 having a pattern of site-isolated regions 701. As shown, substrate 700 has twenty-eight site-isolated regions 701 on the substrate 700. Therefore, in this example, twenty-eight independent experiments may be performed on a single substrate 700.

The substrate 700 may be a wafer having a diameter, such as 300 mm. In other embodiments, substrate 700 may have other shapes, such as square or rectangular. It should be understood that the substrate 700 may be a blanket substrate (i.e., having a substantial uniform surface), a coupon (e.g., partial wafer), or even a patterned substrate having predefined regions, such as site-isolated regions 701.

The site-isolated regions 701 may also have a certain shape, such as circular, rectangular, elliptical, or wedge-shaped. A site-isolated region 701 may be, for example, a test structure, single die, multiple die, portion of a die, other defined portion of the substrate 700, or an undefined area of the substrate 700 that may be subsequently defined through processing.

FIG. 8 is a simplified schematic diagram of a chart 800 listing the pH of a control solution and sample solutions (column 802) after the sample solutions are injected into the system before a decontamination method is applied thereto. Each sample solution is injected into a processing module of a combinatorial processing system after other process fluids were introduced into the processing module. After the sample solutions are injected into the processing module, the solutions are subsequently tested to determine whether the solutions' material and chemical properties have changed. In addition, column 804 of chart 800 shows that the pH material property of the sample solutions before injected into the system was approximately 4.04.

However, after the sample solutions are introduced into the system, the pH of the sample solutions change significantly. For example, the pH of sample solution 1 is approximately 1.19 after the solution is present in the system.

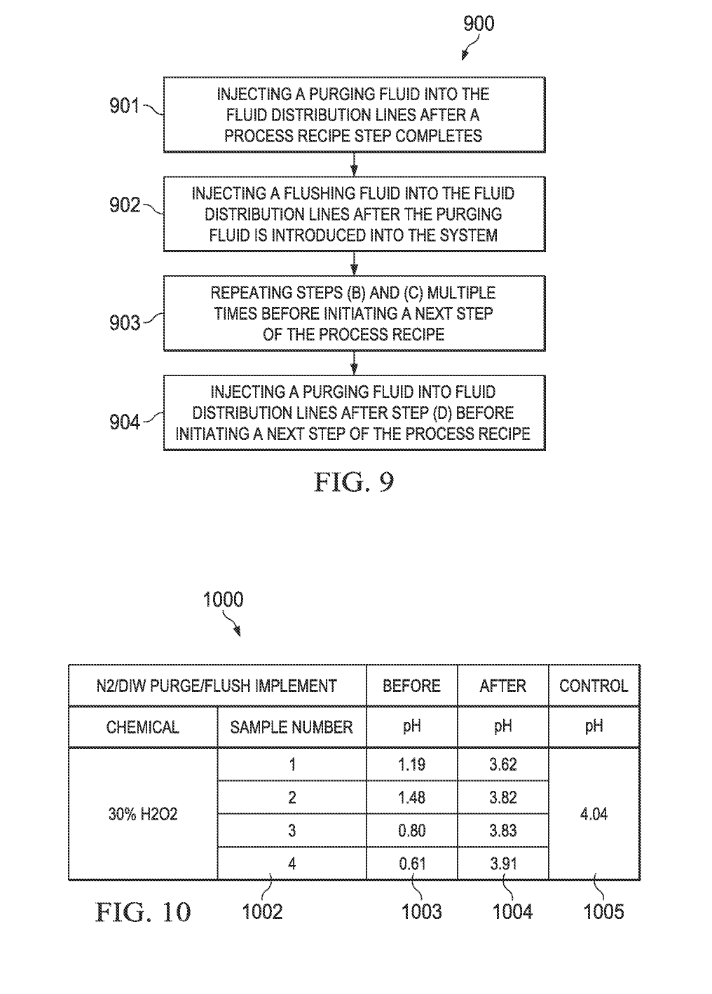

FIG. 9 is a schematic flow diagram of a method 900 to decontaminate components within a processing module of a combinatorial processing system. In some embodiments, the decontamination method may be applied to the combinatorial processing system after each step of a process recipe. More specifically, the decontamination method may be applied to the combinatorial processing system after each set of process fluids are introduced into the system.

Block 901 of method 900 provides injecting purging fluid into the fluid distribution lines after a process recipe step completes. In some embodiments, the purging fluid is an inert gas. For example, N₂ gas may be injected into the fluid distribution lines to purge chemical residue, latent fluids, and other unwanted fluids from the fluid distribution lines to waste. It should be understood by those having ordinary skill in the art that the present disclosure is not limited to N₂ gas but may incorporate any gas or combination of gases which neither react with the process fluids nor the parts and components within the processing system.

The purging fluid (or fluids) may be injected into the fluid distribution lines for approximately five to sixty seconds. In some embodiments, the purging fluid(s) is injected into the fluid distribution lines for approximately twenty seconds. It should be understood that once the purging fluid is injected into the fluid distribution lines, the purging fluid(s) travels throughout the fluid distribution lines, tubing, and sub-components to waste.

Next, block 902 provides injecting a flushing fluid(s) into the fluid distribution lines after the purging fluid(s) is introduced into the system. In some embodiments, the flushing fluid(s) is a purified water. For example, the flushing fluid(s) may also include deionized water or distilled water. In some embodiments, a flushing fluid(s) may flush unwanted fluids, such as a processing chemical (e.g. sulfuric acid) from the fluid distribution lines. Further, the flushing fluid(s) may flush chemical residue, latent fluid, and other unwanted fluids from the fluid distribution lines, tubing, and sub-components to waste.

The flushing fluid may be injected into the fluid distribution lines for approximately five to sixty seconds. In some embodiments, the flushing fluid(s) is injected into the fluid distribution lines for approximately sixty seconds.

In some embodiments, the flushing fluid(s) is injected into the fluid distribution lines within a predefined time period after the purging fluid(s) is introduced into the system. For example, the flushing fluid(s) may be introduced into the system within one minute of injecting the purging fluid(s) into the system. In some embodiments, the flushing fluid(s) is automatically injected into the system right after all of the purging fluid(s) is introduced into the system.

Method 900 further provides repeating steps (a) and (b) multiple times before initiating a next step of the process recipe according to block 903. In some embodiments, steps (a) and (b) are repeated between one and ten times. For example, when steps (a) and (b) are repeated twice, the purging/flushing sequence includes the following:
1) Injecting a purging fluid into the fluid distribution lines after a process recipe step completes;
2) Injecting a flushing fluid into the fluid distribution lines after the purging fluid is introduced into the system;
3) Injecting a purging fluid into the fluid distribution lines after the flushing fluid is introduced into the system;
4) Injecting a flushing fluid into the fluid distribution lines after the purging fluid is introduced into the system;
5) Injecting a purging fluid into the fluid distribution lines after the flushing fluid is introduced into the system;
6) Injecting a flushing fluid into the fluid distribution lines after the purging fluid is introduced into the system;

Steps (a) and (b) may be repeated within a certain time period. For example, steps (a) and (b) may be repeated within sixty seconds from completion of the previous iteration. In addition, steps (a) and (b) may be repeated multiple times within varying ranges of time periods. For example, if a decontamination process consistent with the present disclosure calls for steps (a) and (b) to be repeated twice, the first repetitive iteration may occur within thirty (30) seconds of completion of the first iteration and the second repetitive iteration may occur within (60) seconds of completion of the first repetitive iteration. As such, steps (a) and (b) may be repeated within variable time frames according to predefined time periods.

Finally, block 904 provides injecting a purging fluid into the fluid distribution lines after step (c) before initiating a next step of the process recipe. In some embodiments, the purging fluid may include N₂ gas or any other inert gas. The purging fluid may be injected into the fluid distribution lines for approximately five to sixty seconds. In some embodiments, the purging fluid may be injected into the fluid distribution lines for approximately thirty seconds.

In some embodiments, block 904 may be characterized as re-injecting a purging fluid(s) back into the processing module. As such, in some embodiments, the purging fluid(s) re-injected into the processing module may be the same purging fluid(s) that was introduced into the system in step (a). In contrast, in some embodiments, the purging fluid(s) injected into the system may be different from the purging fluid(s) introduced into the system in step (a).

Most notably, in some embodiments, the decontamination method begins and ends with injecting a purging fluid(s) into the processing module of the combinatorial system. As such, according to some embodiments of the present disclosure, a decontamination method consistent with the present disclosure may be characterized by the following sequence: purging-flushing-purging.

The purging-flushing-purging sequence is advantageous because experimental and empirical data have shown that unwanted fluids may be removed more effectively when the aforementioned order is implemented. Moreover, each phase in the purging-flushing-purging sequence may occur consecutively, without delay, or variably. In addition, the entire purging-flushing-purging sequence may be repeated consecutively, without delay, or variably according to a predefined timetable.

Furthermore, it should be understood that one having ordinary skill in the art that the purging and flushing fluids injected into the fluid distribution lines are delivered from fluid distribution channels.

FIG. 10 is a simplified schematic diagram of a table 1000 listing the pH of sample substances after the substances are injected into the system and after a decontamination method is applied thereto. In particular, column 1002 of table 1000 lists four sample hydrogen peroxide-based solutions which are tested after they are injected into the system but before a decontamination method is applied. Column 1005 shows that the pH of the control hydrogen peroxide-based solution is approximately 4.04.

Most notably, the pH of each sample solution after being injected into the combinatorial system is substantially different from the pH of the control substance. In fact, according to experimental data, the presence of the sample solutions within the combinatorial processing system significantly reduces the pH of the sample substances. Accordingly, it is clear that an effective decontamination process is needed in order for process fluids to maintain their chemical and material properties when inside of the combinatorial processing system. The decontamination method disclosed herein addresses this need.

The pH's of sample chemical 1 and sample chemical 2 after they are injected into the system are 1.19 and 1.48, respectively. Furthermore, the pH's of sample chemical 3 and sample chemical 4 are 0.8 and 0.61, respectively. As such, the experimental data show that the remnants of unwanted chemicals left in the combinatorial processing system from earlier processing affect the chemical properties and processing capability of fluids later injected into the system.

Furthermore, table 1000 also shows the results of the hydrogen peroxide-based chemicals (see column 1004) tested after the sample solutions are injected into the system and after the decontamination method is applied. As shown, the pH's of sample solutions 1-4 injected into the combinatorial processing system after a decontamination method is applied are 3.62, 3.82, 3.83, and 3.91, respectively.

Accordingly, experimental data clearly indicates that the decontamination method applied to the combinatorial processing system is effective in that a decontamination method consistent with the present disclosure mitigates the reduction of the pH of the sample solutions.

It should be understood, however, that testing the sample solutions is not limited to measuring the pH of the sample process fluids. As such, any measurement that can reveal a change in the sample solutions after being injected into the combinatorial system is within the spirit and scope of the present disclosure.

Methods and apparatuses for combinatorial processing have been described. It will be understood that the descriptions of some embodiments of the present disclosure do not limit the various alternative, modified and equivalent embodiments which may be included within the spirit and scope of the present disclosure as defined by the appended claims. Furthermore, in the detailed description above, numerous specific details are set forth to provide an understanding of various embodiments of the present disclosure. However, some embodiments of the present disclosure may be practiced without these specific details.

What is claimed is:

1. A method for decontaminating fluid lines within a combinatorial processing system, the method comprising:
a. injecting a purging fluid into at least one fluid distribution line after at least one step of a process recipe;
b. injecting a flushing fluid into the at least one fluid distribution line after the purging fluid is introduced into the at least one fluid distribution line;
c. repeating steps (a) and (b) multiple times before initiating a next step of the process recipe; and
d. injecting a purging fluid into the at least one fluid distribution line after step (c) before initiating a next step of the process recipe.

2. The method of claim 1, wherein the at least one step of the process recipe includes at least one of wet etch processing, cleaning, polishing, or texturizing.

3. The method of claim 1, wherein the purging fluid is an inert gas.

4. The method of claim 1, wherein the purging fluid is N₂ gas.

5. The method of claim 4, wherein the N₂ gas injected into the at least one fluid distribution line in step (a) occurs between five to sixty seconds.

6. The method of claim 4, wherein the N₂ gas injected into the at least one fluid distribution line in step (a) occurs for approximately twenty seconds.

7. The method of claim 1, wherein the flushing fluid is a purified water.

8. The method of claim 1, wherein the flushing fluid is at least one of deionized water or distilled water.

9. The method of claim 1, wherein the flushing fluid is injected into the at least one fluid distribution line in step (b) occurs between five to sixty seconds.

10. The method of claim 1, wherein the flushing fluid injected into the at least one fluid distribution line in step (b) occurs for approximately sixty seconds.

11. The method of claim 1, wherein steps (a) and (b) are repeated between one and ten times.

12. The method of claim 1, wherein steps (a) and (b) are repeated twice.

13. The method of claim 1, wherein the purging fluid is injected into the at least one fluid distribution line in step (d) occurs between five and sixty seconds.

14. The method of claim 1, wherein the purging fluid injected into the at least one fluid distribution line in step (d) occurs for approximately thirty seconds.

15. The method of claim 1, wherein the purging fluid purges unwanted fluids from the at least one distribution line within the processing module to waste.

16. The method of claim 1, wherein the purging fluid and the flushing fluid injected into the at least one distribution line is dispensed from a fluid distribution channel disposed within a dispense manifold.
